(19) United States
(12) Patent Application Publication
(10) Pub. No.: US 2015/0205355 A1
(43) Pub. Date: Jul. 23, 2015

(54) DYNAMIC TACTILE INTERFACE

(71) Applicant: Tactus Technology, Inc., Fremont, CA (US)

(72) Inventor: Micah Yairi, Fremont, CA (US)

(21) Appl. No.: 14/591,841

(22) Filed: Jan. 7, 2015

Related U.S. Application Data
(60) Provisional application No. 61/924,499, filed on Jan. 7, 2014.

(51) Int. Cl. G06F 3/01; G06F 3/041

(52) U.S. Cl. CPC G06F 3/016; G06F 3/0414; G06F 3/0416

(57) ABSTRACT

A dynamic tactile interface includes a substrate defining a fluid channel, a fluid conduit fluidly coupled to the fluid channel, and an exhaust channel fluidly coupled to the fluid conduit; a tactile layer including a peripheral region coupled to the substrate, a deformable region adjacent the peripheral region and arranged over the fluid conduit, and a tactile surface opposite the substrate; a displacement device displacing fluid into the fluid channel to transition the deformable region from a retracted setting to an expanded setting; a spring element arranged remotely from the deformable region, fluidly coupled to the exhaust channel 116, and buckling from a first position to a second position in response to application of a force on the tactile surface at the deformable region in the expanded setting, the spring element biased toward the exhaust channel in the first position and biased away from the exhaust channel in the second position.

### CROSS-REFERENCE TO RELATED APPLICATIONS

This application claims benefit to U.S. Provisional Patent Application No. 61/924,499, filed 7 Jan. 2014, which is incorporated in its entirety by this reference.

This application is related to U.S. patent application Ser. No. 11/969,848, filed 4 Jan. 2008; U.S. patent application Ser. No. 13/414,589, filed 7 Mar. 2012; U.S. patent application Ser. No. 13/456,010, filed 25 Apr. 2012; U.S. patent application Ser. No. 13/456,031, filed 25 Apr. 2012; U.S. patent application Ser. No. 13/465,737, filed 7 May 2012; U.S. patent application Ser. No. 13/465,772, 7 May 2012; U.S. patent application Ser. No. 14/035,851, filed 24 Sep. 2013; 13/481,676, filed on 25 May 2012; U.S. patent application Ser. No. 14/081,519, filed; and Ser. No. 12/830,430, filed 5 Jul. 2010, all of which are incorporated in their entireties by this reference.

### TECHNICAL FIELD

This invention relates generally to user interfaces and more specifically to a new and useful dynamic tactile interface in the field of user interfaces.

### BRIEF DESCRIPTION OF THE FIGURES

FIGS. 1A, 1B, and 1C are schematic representations of a dynamic tactile interface; and

FIG. 2 is a schematic representation of one variation of the dynamic tactile interface;

FIG. 3 is a schematic representation of one variation of the dynamic tactile interface;

FIGS. 4A, 4B, and 4C are schematic representations of one variation of the dynamic tactile interface;

FIGS. 5A and 5B are schematic representations of one variation of the dynamic tactile interface;

FIG. 6 is a schematic representation of one variation of the dynamic tactile interface;

FIGS. 7A, 7B, and 7C are schematic representations of one variation of the dynamic tactile interface;

FIG. 8 is a flowchart representation of one variation of the dynamic tactile interface;

FIG. 9 is a schematic representation of one variation of the dynamic tactile interface; and

FIG. 10 is a schematic representation of one variation of the dynamic tactile interface.

### DETAILED DESCRIPTION OF THE EMBODIMENTS

The following description of the embodiments of the invention is not intended to limit the invention to these embodiments, but rather to enable any person skilled in the art to make and use this invention.

### 1. Dynamic Tactile Interface and Applications

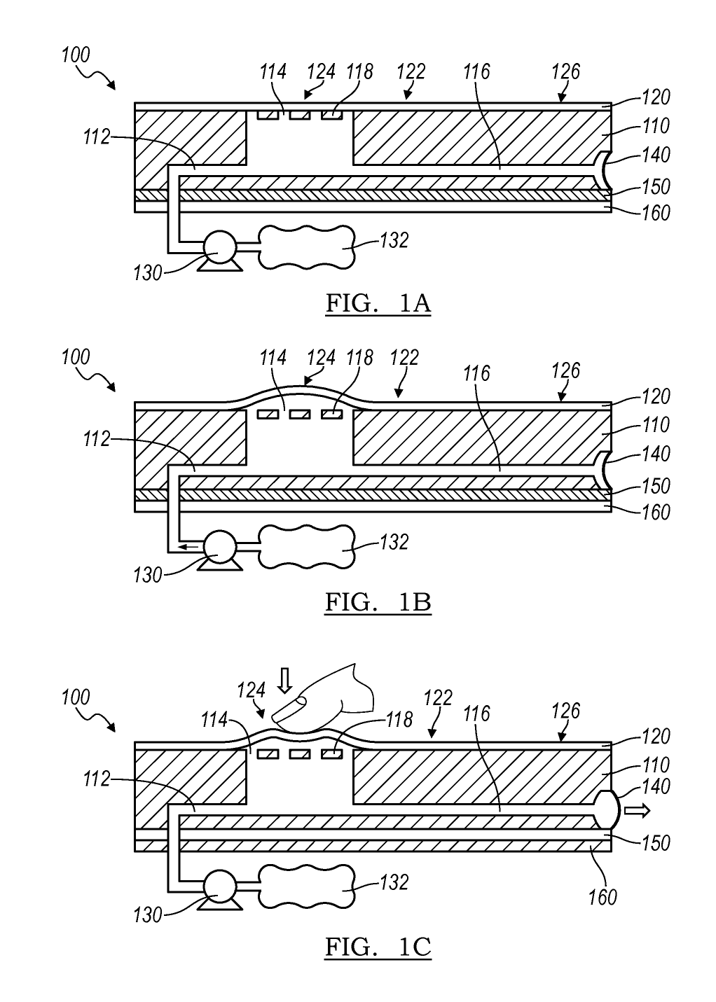

As shown in FIGS. 1A, 1B, and 1C, a dynamic tactile interface 100 includes a substrate 110 defining a fluid channel, a fluid conduit 114 fluidly coupled to the fluid channel, and an exhaust channel 116 fluidly coupled to the fluid conduit; a tactile layer 120 including a peripheral region 122 coupled to the substrate, a deformable region 124 adjacent the peripheral region 122 and arranged over the fluid conduit, and a tactile surface opposite the substrate; a displacement device 130 displacing fluid into the fluid channel 112 to transition the deformable region 124 from a retracted setting to an expanded setting, the deformable region 124 elevated above the peripheral region 122 in the expanded setting; a spring element 140 arranged remotely from the deformable region 124, fluidly coupled to the exhaust channel 116, and buckling from a first position to a second position in response to application of a force on the tactile surface at the deformable region 124 in the expanded setting, the spring element 140 biased toward the exhaust channel 116 in the first position and biased away from the exhaust channel 116 in the second position; and a sensor 181 outputting a signal corresponding to depression of the deformable region 124 in the expanded setting.

Generally, the dynamic tactile interface 100 functions as a physically reconfigurable input surface with input (i.e., deformable) regions that transition between retracted (e.g., flush) and raised (i.e., expanded) settings. The dynamic tactile interface 100 also captures user inputs on the deformable regions during operation of a connected or integrated computing device.

In one example, the dynamic tactile interface 100 is integrated into a mobile computing device, such as a smartphone or a tablet, with the substrate 110 and the tactile layer 120 arranged over a digital display 150 (or a touchscreen) of the device. In this example, the substrate, the tactile layer, and the fluid within the system can be substantially transparent such that the deformable region 124 is flush with the peripheral region 122 and substantially invisible in the retracted setting but expands outwardly above the peripheral region 122 to provide tactile guidance over an input region of the device in the expanded setting. Furthermore, the spring element 140 can be arranged remotely from the deformable region 124, such as beneath a bezel area 126 around the display 150, and can buckle (or snap) from the first position to the second position in response to depression of the deformable region 124 in the expanded setting, thereby yielding a nonlinear depression response at the deformable region 124 (e.g., a click feel). As in this example, the substrate 110 and the tactile layer 120 of the dynamic tactile interface 100 can be substantially transparent and thus arranged over a digital display 150 with the exhaust channel 116 communicating fluid pressure to the spring element 140—arranged in an off-screen region of the device—which buckles when a fluid pressure within the exhaust channel 116 reaches a threshold fluid pressure in response to depression of the deformable region 124.

As described below, the tactile layer 120 can further define multiple (e.g., thirty-two) deformable regions in a keyboard layout, each fluidly coupled to the displacement device 130 via one or more fluid channels and one or more fluid conduits. Each deformable region 124 can correspond to one alphanumeric and/or punctuation character of an alphanumeric keyboard (e.g., a virtual keyboard rendered on a digital display 150 of the device), and the displacement device 130 can pump fluid into the fluid channel(s) and the fluid conduit(s) to transition (all or a selection of) the deformable regions from a retracted setting to an expanded setting in a keyboard arrangement. The display 150 arranged below the substrate 110 can render images of alphanumeric and/or punctuation characters aligned with corresponding deformable regions, and the device can record alphanumeric and/or punctuation selections as corresponding deformable regions are serially depressed by a user. In this configuration, the dynamic tactile interface 100 can also include multiple spring elements, each fluidly (directly) coupled to a single deformable region 124 via a corresponding exhaust channel 116, or each spring element 140 can be fluidly coupled to a subset of deformable regions via corresponding exhaust channels and a manifold. Thus, as the deformable regions are serially depressed—which increases fluid pressure within corresponding exhaust channels—corresponding spring elements can buckle to yield click feels during selection of each deformable region 124. Furthermore, once the keyboard is no longer display 150ed or needed (e.g., when a native messaging application on the device is closed), the displacement device 130 can draw fluid back out of the fluid channel(s) to transition the deformable regions back into the retracted setting.

However, the dynamic tactile interface 100 can be similarly implemented in any other computing device, such as in a laptop computer, a gaming device, a personal music player, etc. The dynamic tactile interface 100 can also be integrated into a standalone keyboard, trackpad, or other input surface or peripheral device for a computing device or incorporated into a dashboard or other control surface within a vehicle (e.g., an automobile), a home appliance, a tool, a wearable device, etc. However, the dynamic tactile interface 100 can be coupled to or integrated into any other suitable device to provide intermittent (e.g., transient) tactile guidance to inputs on a surface.

### 2. Tactile Layer

The tactile layer 120 of the dynamic tactile interface 100 includes a peripheral region 122 coupled to the substrate, a deformable region 124 adjacent the peripheral region 122 and arranged over the fluid conduit, and a tactile surface opposite the substrate. Generally, the tactile layer 120 functions to define a deformable region 124 arranged over one or more fluid conduits such that displacement of fluid into and out of the fluid conduit(s) (i.e., via one or more fluid channels) causes the deformable region 124 to expand and retract, respectively, thereby intermittently yielding a tactilely distinguishable formation at the tactile surface. The tactile layer 120 can also define multiple deformable regions that can be transitioned independently or in groups between the retracted and expanded settings by displacing fluid into and out of one or more corresponding fluid channels, respectively.

The tactile surface defines an interaction surface through which a user can provide an input to an electronic device that incorporates (e.g., integrates) the dynamic tactile interface 100. The deformable region 124 defines a dynamic region of the tactile layer, which can expand to define a tactilely distinguishable formation on the tactile surface in order to, for example, guide a user input to an input region of the electronic device. The tactile layer 120 is attached to the substrate 110 across and/or along a perimeter of the peripheral region 122 (e.g., adjacent or around the deformable region 124) such as in substantially planar form. The deformable region 124 can be substantially flush with the peripheral region 122 in the retracted setting and elevated above the peripheral region 122 in the expanded setting, or the deformable region 124 can be arranged at a position offset vertically above or below the peripheral region 122 in the retracted setting.

The tactile layer 120 is attached to the substrate 110 across and/or along a perimeter of the peripheral region 122 (i.e., adjacent or around the deformable region 124), and the substrate 110 can retain the peripheral region 122 in substantially planar form or in any other suitable form. The deformable region 124 can be substantially flush with the peripheral region 122 in the retracted setting (shown in FIG. 1A) and elevated above the peripheral region 122 in the expanded setting (shown in FIG. 1B), or the deformable region 124 can be arranged at a position offset vertically above or below the peripheral region 122 in the retracted setting.

In one application in which the dynamic tactile interface 100 is integrated or transiently arranged over a display 150 and/or a touchscreen, the tactile layer 120 can be substantially transparent. For example, the tactile layer 120 can include one or more layers of a urethane, polyurethane, silicone, and/or an other transparent material and bonded to the substrate 110 of polycarbonate, acrylic, urethane, PET, glass, and/or silicone, such as described in U.S. patent application Ser. No. 14/035,851. Alternatively, the dynamic tactile interface 100 can be arranged in a peripheral device without a display 150 or remote from a display 150 within a device, and the tactile layer 120 can, thus, be substantially opaque. For example, the substrate 110 can include one or more layers of opaque (colored) silicone adhered to a substrate 110 of aluminum. However, the tactile layer 120 can be of any other form or material coupled to the substrate 110 in any other way at the peripheral region 122 and can define any other number of deformable regions.

The tactile layer 120 can be substantially opaque or semi-opaque (e.g., translucent), such as in an implementation in which the tactile layer 120 is applied over (or otherwise coupled to) a computing device without a display 150. For example, the substrate 110 can include one or more layers of colored opaque silicone adhered to a substrate of aluminum. In this implementation, an opaque tactile layer 120 can yield a dynamic tactile interface 100 on which user inputs are received, for example, a touch sensitive-surface of a computing device. The tactile layer 120 can alternatively be transparent, translucent, or of any other optical clarity suitable for transmitting light emitted by a display 150 across the tactile layer. For example, the tactile layer 120 can include one or more layers of a urethane, polyurethane, silicone, and/or any other transparent material and bonded to the substrate 110 of polycarbonate, acrylic, urethane, PET, glass, and/or silicone, such as described in U.S. patent application Ser. No. 14/035,851. Thus, the tactile layer 120 can function as a dynamic tactile interface 100 for the purpose of guiding—with the deformable region 124—an input to on a region over the display 150 corresponding to a rendered image of an input key. For example, the deformable regions can function as a transient physical keys corresponding to discrete virtual keys of a virtual keyboard rendered on a display 150 coupled to the dynamic tactile interface 100.

The tactile layer 120 can be elastic (or flexible, malleable, and/or extensible) such that the tactile layer 120 can transition between the expanded setting and the retracted setting at the deformable region 124. As the peripheral region 122 can be attached to the substrate, the peripheral region 122 can substantially maintain its position (e.g., a planar configuration) as the deformable region 124 transitions between the expanded setting and retracted setting. Alternatively, the tactile layer 120 can include both an elastic portion and a substantially inelastic (e.g., rigid) portion. The elastic portion can define the deformable region 124; the inelastic portion can define the peripheral region. Thus, the elastic portion can transition between the expanded and retracted setting, and the inelastic portion can maintain its (planar) configuration as the deformable region 124 transitions between the expanded setting and retracted setting. The tactile layer 120 can be of one or more layers of PMMA (e.g., acrylic), silicone, polyurethane elastomer, urethane, PETG, polycarbonate, or PVC. Alternatively, the tactile layer 120 can be of one or more layers of any other material suitable for transitioning between the expanded setting and retracted setting at the deformable region 124.

The tactile layer 120 can include one or more sublayers of similar or dissimilar materials. For example, the tactile layer 120 can include a silicone elastomer sublayer adjacent the substrate 110 and a polycarbonate sublayer joined to the silicone elastomer sublayer and defining the tactile surface. Optical properties of the tactile layer 120 can be modified by impregnating, extruding, molding, or otherwise incorporating particulate (e.g., metal oxide nanoparticles) into the layer and/or one or more sublayers of the tactile layer.

In the expanded setting, the deformable region 124 defines a tactilely distinguishable formation. For example, the deformable region 124 in the expanded setting can be dome-shaped, ridge-shaped, ring-shaped, crescent-shaped, or of any other suitable form or geometry. The deformable region 124 can be substantially flush with the peripheral region 122 in the retracted setting, and the deformable region 124 can thus be offset above the peripheral region 122 in the expanded setting. When fluid is (actively or passively) released from behind the deformable region 124 of the tactile layer, the deformable region 124 can transition back into the retracted setting (shown in FIG. 1A). Alternatively, the deformable region 124 can transition between a depressed setting and a flush setting, the deformable region 124 in the depressed setting offset below flush with the peripheral region 122 and deformed inward toward the fluid conduit, and the deformable region 124 setting substantially flush with the peripheral region 122 in the expanded setting. Additionally, the deformable regions can transition between elevated positions of various heights relative to the peripheral region 122 to selectively and intermittently provide tactile guidance at the tactile surface over a touchscreen (or over any other surface). However, the deformable region 124 can achieve any other vertical position relative to the peripheral region 122 in the expanded setting and retracted setting.

As shown in FIG. 1A, one variation of the dynamic tactile interface 100 includes a (rigid) platen coupled to the attachment surface at the deformable region 124 and movably arranged in the fluid conduit, the platen supporting the deformable region 124 to define a flat-top button at the deformable region 124 in the expanded setting and a flush surface in the retracted setting. Thus, the platen, which can be rigid, can be arranged within or coupled to the deformable region 124. Generally, the platen can function to maintain a surface of the tactile layer 120 at the deformable region 124 in a substantially constant (e.g., planar) form between the expanded setting and retracted setting. In this variation, a perimeter of the deformable region 124 between the peripheral region 122 and the platen can, thus, elongate (e.g., stretch) and shrink as the deformable region 124 transitions into the expanded setting and then back into the retracted setting, respectively. The platen can be substantially thin, such as a planar puck (e.g., disc) coupled to the tactile layer 120 at the deformable region 124 opposite the tactile surface. In this implementation, the substrate 110 can define a recessed shelf under the tactile layer 120 and around the fluid conduit, and the platen can engage the shelf supporting the tactile layer in the retracted setting (e.g., flush with the peripheral region 122), as shown in FIG. 1A. Then, in this implementation, when the displacement device 130 pumps fluid into the fluid channel 112 to transition the deformable region 124 into the expanded setting, the platen can rise off of the shelf and retain an area of the tactile surface at the deformable region 124 in a planar form vertically offset from the peripheral region, a region of the deformable region 124 between the platen and the peripheral region 122 (e.g., a region of the tactile layer 120 not bonded to the substrate 110 or to the platen) stretching to accommodate expansion of the deformable region 124, as shown in FIG. 1B. Thus, in this example, the platen can function to yield a flat button across the deformable region 124 in the expanded setting.

In a similar implementation, the tactile layer 120 includes two sublayers, and the platen is arranged between the two sublayers at the deformable region 124 with the two sublayers bonded together. The substrate 110 can similarly define a recess configured to accommodate the increased thickness of the deformable region 124 across the platen. Alternatively, in this implementation, one or both of the sublayers can be recessed across the platen to yield a tactile layer 120 of substantially constant thickness. Yet alternatively, the platen can extend into the fluid conduit. The platen can also be hinged or otherwise coupled to the substrate 110 such that the deformable region 124 defines a planar surface substantially nonparallel (e.g., inclined against) the planar tactile surface at the peripheral region 122 in the expanded setting. The platen can also retain an area of the tactile surface across the deformable region 124 in any other form, such as in a curvilinear, stepped, or recessed form.

In the foregoing variation, the platen can include a rigid transparent material (e.g., polycarbonate for the dynamic tactile interface 100 arranged over a display or touchscreen) or a rigid opaque material (e.g., acetal for the dynamic tactile interface 100 not arranged over a display 150 or touchscreen). However, the platen can be of any other material of any other form coupled to the deformable region 124 in any other suitable way.

However, the tactile layer 120 can be of any other suitable material and can function in any other way to yield a tactilely distinguishable formation at the tactile surface.

### 3. Substrate

The substrate 110 of the dynamic tactile interface 100 defines a fluid channel, a fluid conduit 114 fluidly coupled to the fluid channel, and an exhaust channel 116 fluidly coupled to the fluid conduit. Generally, the substrate 110 functions to define a fluid circuit between the displacement device, the deformable region 124, and the spring element. The substrate 110 also functions to support and retain the peripheral region 122 of the tactile layer, such as described in U.S. patent application Ser. No. 14/035,851. Alternatively, the substrate 110 and the tactile layer 120 can be supported by a touchscreen once installed on a computing device. For example, the substrate 110 can be of a material and and/or a rigidity similarly to that of the tactile layer, and the substrate 110 and the tactile layer 120 can derive support (e.g., rigidity) from an adjacent touchscreen of a computing device. The substrate 110 can further define a support member 118 to support the deformable region 124 against inward deformation past the peripheral region.

The substrate 110 can be substantially transparent or translucent. For example, in one implementation, wherein the dynamic tactile interface 100 includes or is coupled to a display 150, the substrate 110 can be substantially transparent and transmit light output from an adjacent display 150. The substrate 110 can be PMMA, acrylic, and/or of any other suitable transparent or translucent material. The substrate 110 can alternatively be surface-treated or chemically-altered PMMA, glass, chemically-strengthened alkali-aluminosilicate glass, polycarbonate, acrylic, polyvinyl chloride (PVC), glycol-modified polyethylene terephthalate (PETG), polyurethane, a silicone-based elastomer, or any other suitable translucent or transparent material or combination thereof. In one application in which the dynamic tactile interface 100 is integrated or transiently arranged over a display 150 and/or a touchscreen, the substrate 110 can be substantially transparent. For example, the substrate 110 can include one or more layers of a glass, acrylic, polycarbonate, silicone, and/or other transparent material in which the fluid channel 112 and fluid conduit 114 are cast, molded, stamped, machined, or otherwise formed.

Alternatively (or additionally), the substrate 110 can be substantially opaque or otherwise substantially non-transparent or translucent. For example, the substrate 110 can be opaque and arranged over an off-screen region of a mobile computing device. In another example application, the dynamic tactile interface 100 can be arranged in a peripheral device without a display 150 or remote from a display 150 within a device, and the substrate 110 can, thus, be substantially opaque. Thus, the substrate 110 can include one or more layers of nylon, acetal, delrin, aluminum, steel, or other substantially opaque material.

Additionally, the substrate 110 can include one or more transparent, translucent, or opaque materials. For example, the substrate 110 can include a glass base sublayer bonded to walls or boundaries of the fluid channel 112 and the fluid conduit. The substrate 110 can also include a deposited layer of material exhibiting adhesive properties (e.g., an adhesive tie layer or film of silicon oxide film). The deposited layer can be distributed across an attachment surface of the substrate 110 to which the tactile layer 120 adheres and can function to retain the peripheral region 122 of the tactile layer 120 to the attachment surface of the substrate 110 throughout changes in fluid pressure behind the deformable region 124. Additionally, the substrate 110 can be substantially relatively rigid, relatively elastic, or exhibit any other mechanical property. However, the substrate 110 can be formed in any other way, be of any other material, and exhibit any other property suitable to support the tactile layer 120 and define the fluid conduit 114 and fluid channel.

The substrate 110 can define the attachment surface, which functions to retain (e.g., hold, bond, and/or maintain the position of) the peripheral region 122 of the tactile layer 120. In one implementation, the substrate 110 is planar across the attachment surface such that the substrate 110 retains the peripheral region 122 of the tactile layer 120 in planar form, such as described in U.S. patent application Ser. No. 12/652,708. However, the attachment surface of the substrate 110 can be of any other geometry and retain the tactile layer 120 in any other suitable form. For example, the substrate 110 can define a substantially planar surface at the attachment surface and a support member 118 extending from the attachment surface and adjacent the tactile layer 120, the attachment surface retaining the peripheral region 122 of the tactile layer, and the support member 118 substantially continuous with the attachment surface. The support member 118 can thus support the deformable region 124 against substantial inward deformation into the fluid conduit 114, such as in response to an input or other force applied to the tactile surface at the deformable region 124. In this example, the substrate 110 can define the fluid conduit, which passes through the support member, and the attachment surface can retain the peripheral region 122 in substantially planar form. The deformable region 124 can rest on and/or be supported in planar form against the support member 118 in the retracted setting, and the deformable region 124 can be elevated off of the support member 118 in the expanded setting. In this implementation, the support member 118 can define a fluid port through the support member, such that the fluid port communicates fluid from the fluid conduit 114 communicates through the support member 118 and toward the deformable region 124 to transition the deformable region 124 from the retracted setting to the expanded setting.

The substrate 110 can define (or cooperate with the tactile layer, a display 150, etc. to define) the fluid conduit 114 that communicates fluid from the fluid channel 112 to the deformable region 124 of the tactile layer. The fluid conduit 114 can correspond to (e.g., be in fluid communication with) the deformable region 124 of the tactile layer. The fluid conduit 114 can be machined, molded, stamped, etched, etc. into or through the substrate 110 and can be fluidly coupled to the fluid channel 112, the displacement device, and the deformable region 124. A bore intersecting the fluid channel 112 can define the fluid conduit 114 such that fluid can be communicated from the fluid channel 112 toward the fluid conduit, thereby transitioning the deformable region 124 from the expanded setting to the retracted setting. The axis of the fluid conduit 114 can be normal a surface of the substrate, can be non-perpendicular with the surface of the substrate, can be of non-uniform cross-section, and/or can be of any other shape or geometry. For example, the fluid conduit 114 can define a crescent-shaped cross-section. In this example, the deformable region 124 can be coupled to (e.g., be bonded to) the substrate 110 along the periphery of the fluid conduit. Thus, the deformable region 124 can define a crescent-shape offset above the peripheral region 122 in the expanded setting.

The substrate 110 can define (or cooperate with the sensor 181, a display 150, etc. to define) the fluid channel 112 that communicates fluid through or across the substrate 110 to the fluid conduit. For example, the fluid channel 112 can be machined or stamped into the back of the substrate 110 opposite the attachment surface, such as in the form of an open trench or a set of parallel open trenches. The open trenches can then be closed with a backing layer (e.g., the substrate 110), the sensor 181, and/or a display 150 to form the fluid channel. A bore intersecting the open trench and passing through the attachment surface can define the fluid conduit, such that fluid can be communicated from the fluid channel 112 to the fluid conduit 114 (and toward the tactile layer) to transition the deformable region 124 (adjacent the fluid conduit) between the expanded setting and the retracted setting. The axis of the fluid conduit 114 can be normal the attachment surface, can be non-perpendicular with the attachment surface, of non-uniform cross-section, and/or can be of any other shape or geometry. Likewise, the fluid channel 112 can be parallel the attachment surface, normal the attachment surface, non-perpendicular with the attachment surface, of non-uniform cross-section, and/or of any other shape or geometry. However, the fluid channel 112 and the fluid conduit 114 can be formed in any other suitable way and be of any other geometry.

In one implementation, the substrate 110 can define a set of fluid channels. Each fluid channel 112 in the set of fluid channels can be fluidly coupled to a fluid conduit 114 in a set of fluid conduits. Thus, each fluid channel 112 can correspond to a particular fluid conduit 114 and, thus, to a particular deformable region 124. Alternatively, the substrate 110 can define the fluid channel, such that the fluid channel 112 can be fluidly coupled to each fluid conduit 114 in the set of fluid conduits, each fluid conduit 114 fluidly coupled to the fluid channel in series along the length of the fluid channel. Thus, each fluid channel 112 can correspond to a particular set of fluid conduits and, thus, to a particular deformable regions.

In one implementation, as shown in FIG. 1A, the substrate 110 defines a channel of constant cross-section and depth and including a first end and a second end, and the fluid conduit 114 intersects the channel between the first and second ends. In this implementation, the fluid channel 112 is physically coextensive with the channel between the first end and the fluid conduit 114, and the exhaust channel 116 is physically coextensive with the channel between the fluid conduit 114 and the second end. The displacement device 130 (and/or a valve) is coupled to the first end of the channel, and the spring element 140 is coupled to the second end of the channel.

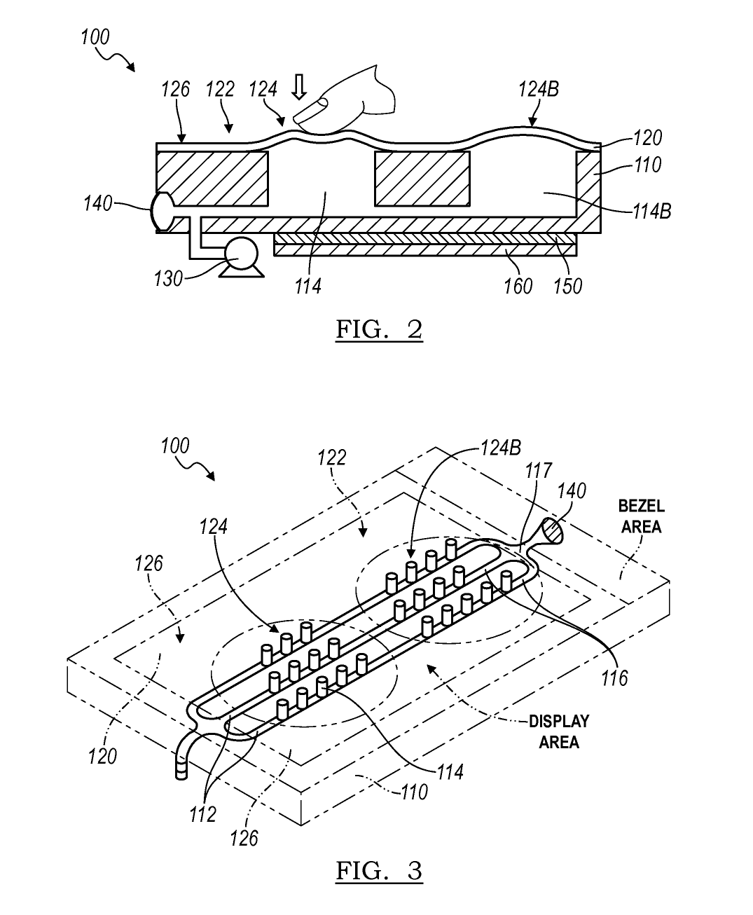

In a similar implementation, as shown in FIG. 2, the substrate 110 defines multiple parallel and offset fluid channels and multiple fluid conduits, each fluid conduit 114 coupled to one fluid channel 112 and adjacent the deformable region 124. In this implementation, the substrate 110 can also define an exhaust conduit configured to communicate fluid (and fluid pressure) from adjacent the deformable region 124 to the exhaust channel 116, and the exhaust channel 116 can communicate fluid (and fluid pressure) from the exhaust conduit toward the spring element. As shown in FIG. 3, the substrate 110 can further define multiple (parallel and offset) exhaust conduits, each fluidly coupled to a first end of an exhaust channel 116 in a set of exhaust channels, and the substrate 110 can define an exhaust manifold that unites the second ends of the exhaust channels. In this implementation, the spring element 140 can be fluidly coupled to (e.g., sealed over) an outlet of the manifold. Alternatively, the exhaust channel 116 and the fluid channel 112 can be physically coextensive, and the spring element 140 can be fluidly coupled to the fluid channel 112 between the displacement device 130 and the fluid conduit, as shown in FIG. 2.

As described above, the tactile layer 120 can define multiple deformable regions, and the substrate 110 can, thus, define multiple fluid channels and/or fluid conduits that fluidly couple corresponding deformable regions to one or more displacement devices and/or valves within the dynamic tactile interface 100. The substrate 110 can also define one exhaust channel 116 per deformable region 124 (or per subset of deformable regions), and the dynamic tactile interface 100 can include one spring element 140 coupled to each exhaust channel 116 such that depression of each deformable region 124 in the set of deformable regions causes a corresponding spring element to buckle, thereby enabling an independent “click” (e.g., “snap”) response at each of the deformable regions. Alternatively, the substrate 110 can define a manifold that unites a set (e.g., two or three) exhaust channels, and the dynamic tactile interface 100 can include one spring element 140 per manifold such that multiple deformable regions share a single spring element, as shown in FIG. 3. For example, the substrate 110 can define a manifold that unites two exhaust channels fluidly coupled to two particular deformable regions, wherein the particular deformable regions corresponding to a pair of alphanumeric characters of a keyboard unlikely to be entered in series, such as “X” and “C” or “V” and “B.” Thus, when one of the two deformable regions is selected while a user is typing on the device, a spring element coupled to a manifold can buckle when one of the two particular deformable regions is depressed (e.g., to yield a snap or click feel at the selected deformable region) and then return to the first position when the deformable region is released and before the other of the two particular deformable regions is depressed.

However, the substrate 110 can define any other number of fluid channels, fluid conduits, exhaust channels, exhaust conduits, and/or manifolds in any other suitable arrangement or configuration. The substrate 110 can also define the fluid channel 112 of a straight or linear geometry, a serpentine geometry, a boustrophedonic geometry, or any other suitable geometry of constant or varying cross-section and at constant or varying depth within the substrate. The substrate 110 can similarly define the exhaust channel 116 of such geometries, cross-sections, and/or depths. For example, the substrate no can also define a second fluid conduit 114 fluidly coupled to the fluid channel 112 and a second exhaust channel 116 fluidly coupled to the fluid conduit.

The substrate 110 can also define a bezel area 126 about a periphery of the substrate no and support the spring element 140 adjacent the bezel area 126 area. In one example, the bezel area 126 can be defined about a periphery of a display 150 of a computing device. In this example, the bezel area 126 can be substantially opaque. A center area of the substrate no arranged over the display 150 can be substantially transparent in order to communicate images rendered by the display 150 across the substrate. The (opaque) spring element 140 can be arranged adjacent (or under) the bezel area 126 area, such that the spring element 140 does not obstruct images rendered by the display 150. Thus, the bezel area 126 can function as a border region under which opaque components, such as the displacement device 130 and the spring element(s), can be arranged (or coupled) in order to hide the opaque components from plain view of a user and prevent obstruction of images rendered by the display 150 by the opaque components.

However, the substrate 110 can be manufactured in any other way and of any other material to fluidly couple the displacement device 130 to the deformable region 124.

### 4. Displacement Device

The displacement device 130 of the dynamic tactile interface 100 displaces fluid into the fluid channel 112 to transition the deformable region 124 from a retracted setting to an expanded setting, wherein the deformable region 124 is elevated above the peripheral region 122 in the expanded setting. Generally, the displacement device 130 functions to pump fluid into and/or out of the fluid channel 112 to transition the deformable region 124 into the expanded and retracted settings, respectively. The displacement device 130 can be fluidly coupled to the displacement device 130 via the fluid channel 112 and the fluid conduits and can further displace fluid from a reservoir 132 toward the deformable region 124, such as through one or more valves. For example, the displacement device 130 can pump a transparent liquid, such as water, silicone oil, or alcohol within a closed and sealed system. Alternatively, the displacement device 130 can pump air within a sealed system on in a system open to ambient air. For example, the displacement device 130 can pump air from ambient into the fluid channel 112 to transition the deformable region 124 into the expanded setting, and the displacement device 130 (or an exhaust valve) can (actively or passively) exhaust air in the fluid channel 112 to ambient to return the deformable region 124 into the retracted setting.

The displacement device, one or more valves, the substrate, the tactile layer, and/or the spring element 140 can also cooperate to seal fluid within the fluid system to retain the deformable region 124 in a current setting (e.g., the expanded setting and/or the retracted setting). For example, once the displacement device 130 pumps a fluid into the fluid system up to a prescribed fluid pressure corresponding to a target height of the deformable region 124, a valve between the displacement device 130 and the fluid channel 112 can close, thus trapping fluid within the fluid system.

The displacement device 130 can be electrically powered or manually powered and can transition multiple deformable regions—either independently or in groups—into the expanded and retracted settings in response to any suitable input.

The dynamic tactile interface 100 can also include multiple displacement devices, such as one displacement device 130 that pumps fluid into the fluid channel 112 to expand the deformable region 124 and one displacement device that pumps fluid out of the fluid channel 112 to retract the deformable region 124. However, the displacement device 130 can function in any other way to transition the deformable region 124 between the expanded and retracted settings.

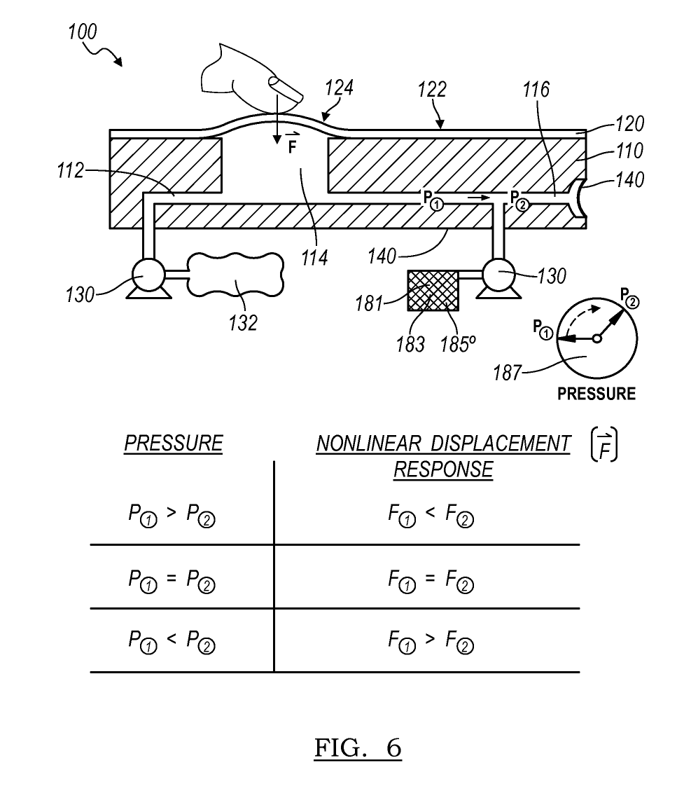

The displacement device 130 pumps fluid (e.g., a liquid or a gas) into the fluid channel 112 to transition the deformable region 124 from a retracted setting to an expanded setting (i.e., to move the deformable region 124 between two tactilely-distinguishable positions). Once the deformable region 124 reaches a desired height or expanded volume, the dynamic tactile interface 100 can lock the deformable region 124 in the expanded setting, such as by closing a valve between the fluid channel 112 and the displacement device, thereby sealing a volume (or mass) of fluid within the fluid circuit. Subsequently, when the deformable region 124 is depressed by a user, such as with a finger or stylus, the exhaust channel 116 can communicate fluid and/or a change in fluid pressure within the fluid circuit from the deformable region 124 toward the spring element. The exhaust channel 116 can, thus, communicate fluid and/or changes in fluid pressure proximal the deformable region 124 to the spring element, which can be substantially remote (i.e., removed) from the deformable region 124. For example, the substrate 110 and the tactile layer 120 can be arranged over a display 150 of a device, and the substrate 110, the tactile layer 120, and the working fluid can be of substantially transparent materials. In this example, the spring element 140 can be arranged in an off-screen (bezel area 126) area of the device, such as under a bezel area 126 adjacent the display 150, such that light transmission from the display 150 is not obstructed by the spring element, which can be of a metal or other opaque material. As shown in FIG. 6, the second displacement device can be fluidly coupled to the control surface of the spring element and manually actuatable to displace fluid toward the control channel to increase a pressure differential across the spring element

### 5. Spring Element

The spring element 140 is arranged remotely from the deformable region 124, is fluidly coupled to the exhaust channel 116, and buckles from a first position to a second position in response to application of a force on the tactile surface at the deformable region 124 in the expanded setting. The spring element 140 is further biased toward the exhaust channel 116 in the first position and is biased away from the exhaust channel 116 in the second position. Generally, the spring element 140 functions to yield a nonlinear depression response at the deformable region 124 as the deformable region 124 is depressed, such as by a user with a finger or a stylus. In particular, as the deformable region 124 in the expanded setting is depressed by a user, such as with a finger or within a stylus, the spring element 140 can buckle from the first position to the second position, thereby altering a sensation (i.e., a force v. displacement response) of the deformable region 124. For example, the spring element 140 can include a snapdome sealed over a far end of the exhaust channel 116 (e.g., under a bezel area 126 of the substrate 110, proximal a periphery of the device, and remote from the deformable region 124) to provide a non-linear response to depression of the deformable region 124 in the expanded setting by buckling under increased fluid pressure within the exhaust channel 116 as the deformable region 124 is depressed. In this example, when the deformable region 124 in the expanded setting is depressed, fluid behind the deformable region 124 moves into the fluid channel 112 and toward the spring element 140 (initially in the first position), thereby causing the spring element 140 to buckle from the first position to the second position. Once the user releases his finger or the stylus from the deformable region 124, fluid pressure within the closed fluid system can return to a lower steady-state pressure, and the spring element 140 can return to the (default) first position, thereby displacing fluid through the fluid channel 112 back toward the deformable region.

The spring element 140 can, therefore, momentarily snap into the second position in response to depression of the deformable region 124, thereby yielding a “click” effect (e.g., a “snap” or click or sensation for a user) at the deformable region 124 as the inward displacement of the deformable region 124 increases substantially with a relatively small increase in applied force on the deformable region 124 when the spring element 140 buckles from the first position to the second position. The spring element 140 can, thus, cooperate with the deformable region 124 to mimic a sensation of a mechanical snap button at the deformable region 124.

In one implementation, the spring element 140 is sealed over an end of the exhaust channel 116 opposite the deformable region 124 and is stable in a first position distended toward the exhaust channel 116 up to at least a maximum fluid pressure generated within the fluid system by the displacement device. Thus, the spring element 140 can mechanically couple to the substrate 110 and seal about an outlet of the exhaust channel. However, when depression of the deformable region 124 causes fluid pressure within the fluid system to increase above a threshold fluid pressure, the spring element 140 buckles into the second position away from the exhaust channel. When the deformable region 124 is released and fluid pressure within the fluid system drops, the spring element 140 returns to the first position. To transition the deformable region 124 into the expanded setting, the displacement device can displace fluid into the fluid channel 112 by pumping fluid into the fluid channel 112 up to and not (substantially) exceeding a target fluid pressure within the fluid system, and the target fluid pressure fr the dynamic tactile interface 100 can be set based on a surface area of a deformable portion of the spring element 140 facing the exhaust channel 116 such that the spring element 140 does not buckle until depression of the deformable region 124 causes the fluid pressure within the fluid system to rise above the target fluid pressure. The spring element 140 can, therefore, be similarly selected for the surface area of its deformable portion and for its maximum load (i.e., force) before buckling such that a target height of the deformable region 124 in the expanded setting can be achieved at approximately (or below) the target fluid pressure (which can be a function of the elasticity or other mechanical property of the tactile layer at the deformable region 124). The spring element 140 can also be similarly selected for its volume displacement over its full range of travel, its travel (i.e., linear displacement between the first and second positions), release force, actuation force, height, thickness, diameter, etc.

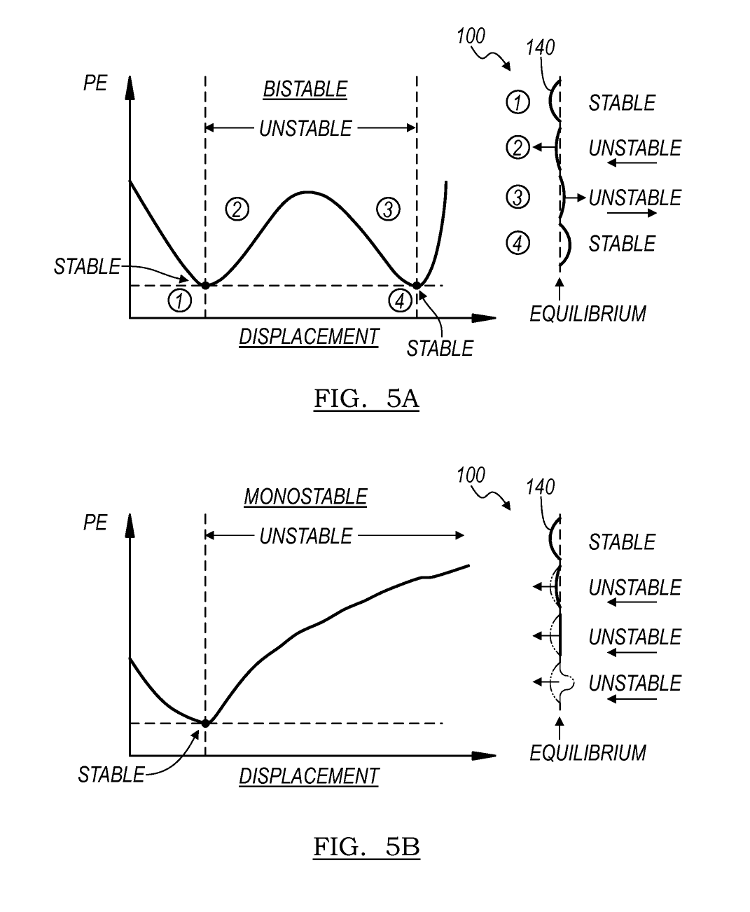

The spring element 140 can be an elastic (and/or elastomeric) diaphragm (e.g., Silicone or rubber), a bistable snapdome, a (monostable) spring-loaded piston, or any other spring-like device suitable to buckle elastically from the first position to the second position. For example, the spring element 140 can include a metallic snap dome stable in the first position and volatile in the second position, as shown in FIG. 5B. The metallic snap dome can be surrounded by an elastomeric diaphragm that prevents fluid from flowing between the exhaust channel 116 and the fluid channel. The spring element 140 can be coupled to the substrate no along an interior surface of the exhaust channel 116 or fluid channel. Alternatively, the spring element 140 can be coupled to any other surface of the substrate 110 to substantially cover an opening of the exhaust channel.

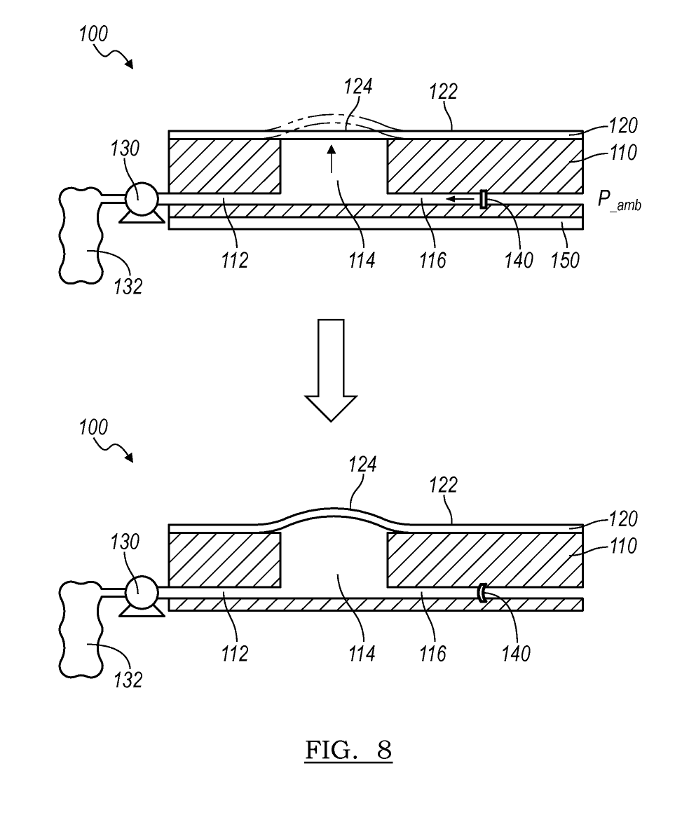

In one example application, the tactile layer 120 can define a set of deformable regions, each deformable region 124 in the set of deformable regions arranged over a corresponding fluid conduit 114 (defined by the substrate) in a set of fluid conduits. Each fluid conduit 114 can be fluidly coupled to the fluid channel, such that fluid can communicate between the fluid channel 112 and the fluid conduit. The fluid channel 112 can be fluidly coupled to the exhaust channel 116, the spring element 140 arranged between the fluid channel 112 and the exhaust channel. The spring element 140 can be an elastic diaphragm (e.g., made of rubber), defining an interior surface adjacent the fluid channel 112 and an exterior surface adjacent the exhaust channel. An end of the exhaust channel 116 opposite the spring element 140 can be open to ambient conditions as shown in FIG. 8. Thus, pressure on the exterior surface can be substantially atmospheric. The spring element 140 can buckle (away from the exhaust channel) in response to elevation of fluid pressure within the fluid channel 112 about a threshold buckling pressure responsive to application of a force on the deformable region 124.

In the foregoing implementation, the back surface of the spring element 140 (opposite the exhaust channel) can be open to ambient air (e.g., exposed to ambient conditions), as shown in FIG. 8. In this implementation, the spring element 140 defines an exterior surface opposite the exhaust channel 116, the exterior surface open to ambient. For example, the spring element 140 can be arranged remotely from the deformable region 124 over an end of the exhaust channel. In this example, the tactile layer 120 and substrate 110 can be arranged over a display 150 of a computing device. The end of the exhaust channel 116 extends from the fluid conduit 114 over the display 150 to under the bezel area 126 adjacent (e.g., proximal a periphery of) the display 150. The exhaust channel 116 can open to ambient (e.g., atmospheric pressure air), the spring element 140 defining the interface between the exhaust channel 116 and ambient. The exterior surface of the spring element 140 can be adjacent air surrounding the dynamic tactile interface 100 and, thus, open to ambient. Thus, the spring element 140 can function as a diaphragm of a diaphragm-type differential pressure gauge.

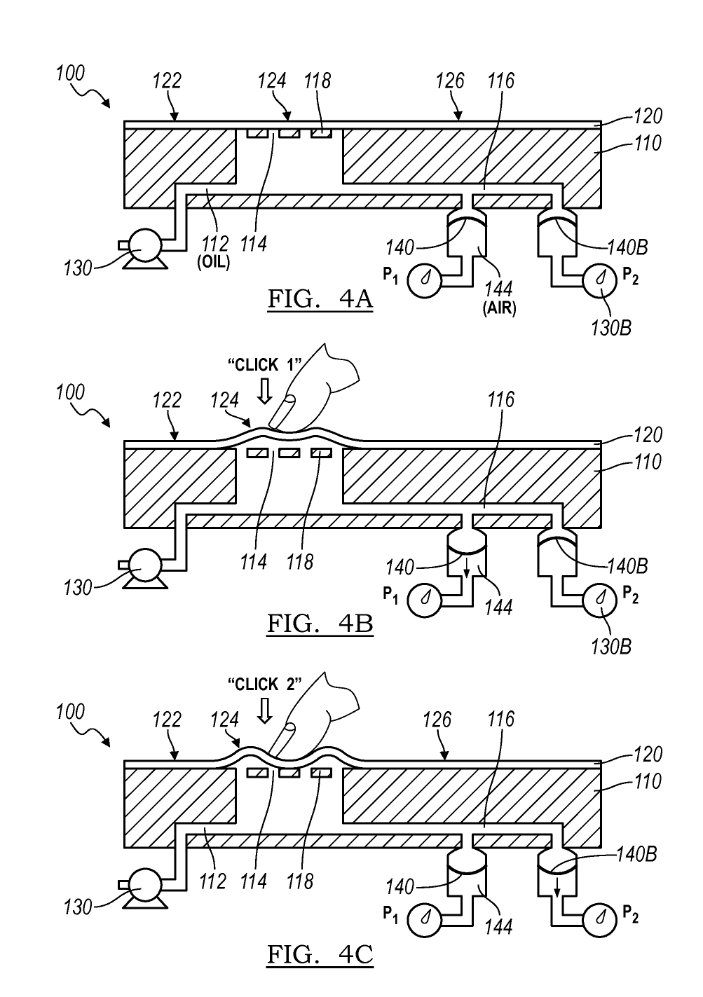

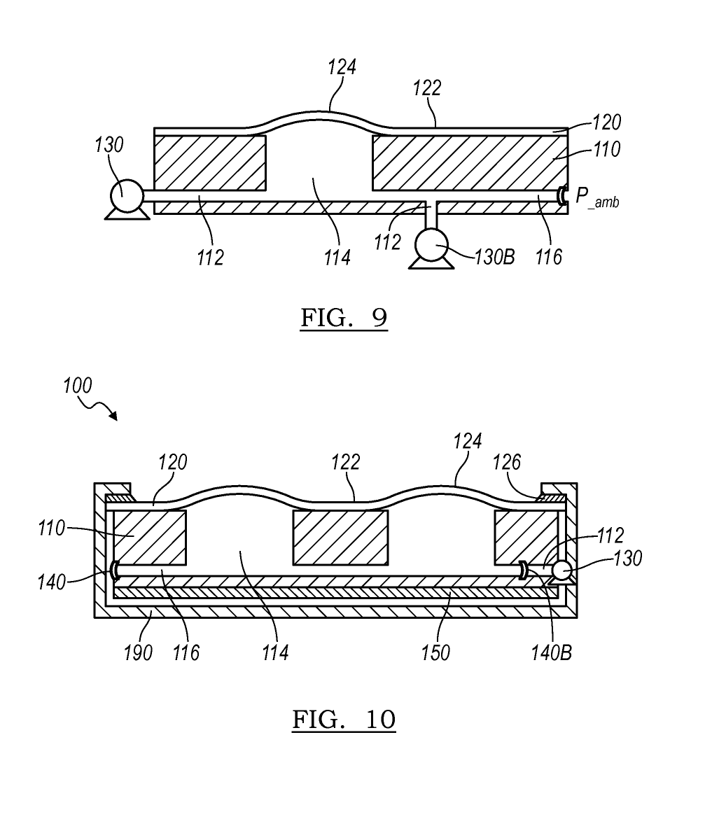

Alternatively, the back surface of the spring element 140 can be open to a closed and sealed volume of compressible fluid (e.g., air). In this example, the compressible fluid can act as a spring to resist buckling of the spring element, and the size and/or maximum load of the spring element, the elasticity of the tactile layer, and/or the target fluid pressure within the fluid system at the expanded setting can be selected or set accordingly. Yet alternatively, the back surface of the spring element 140 can be open to a closed volume 144, and, as shown in FIG. 9, the dynamic tactile interface 100 can include a second displacement device 130B that pumps a compressible fluid into (and out of) the closed volume 144 to control the fluid pressure within the closed volume 144, thereby controlling a peak load on the exhaust channel-side of the spring element 140 that the spring element 140 can withstand before buckling, as shown in FIG. 4A. For example, the second displacement device 130B can automatically adjust the fluid pressure within the closed volume 144 based on an ambient pressure proximal the device to maintain a substantially consistent snap feel at the deformable region 124 at different altitudes (e.g., based on a ratio of the surface area of the deformable region 124 to the surface area of the back of the spring element). In another example shown in FIG. 9, the second displacement device 130B can modulate the fluid pressure within the closed volume 144 based on a user preference specifying a depression distance of (or force on) the deformable region 124 that triggers the spring element 140 to buckle. In a similar example, the second displacement device 130B can modulate the fluid pressure within the closed volume 144 to control a maximum load on the exhaust channel-side of the spring element 140 before buckling to compensate for a change in stiffness and/or offset height of the deformable region 124 customized for the computing device by the user.

In another implementation, the deformable region 124 defines a first internal surface open to (e.g., adjacent the fluid in) the fluid conduit 114 and of a first surface area; and the spring element 140 defines a second internal surface open to (e.g., adjacent the fluid in) the exhaust channel 116 and of a second surface area less than the first surface area. Because the first surface area is greater than the second surface area, under equilibrium pressure conditions within the fluid system, fluid in the fluid system applies a greater force on the first internal surface of the deformable region 124 than on the second surface area of the spring element 140. Thus, the displacement device can pump fluid into the fluid system up to a target pressure (less than a yield pressure of the spring element 140) to transition the deformable region 124 into the expanded setting without triggering the spring element 140 to buckle into the second position. (Alternatively, the displacement device can pump fluid into the system at a pressure exceeding a yield pressure of the spring element, the spring element 140 can buckle during this transition, and the spring element can buckle back into the first position once the deformable region 124 is fully transitioned and an equilibrium fluid pressure within the fluid system is reached). The deformable region 124 and the spring element 140 can be sized or otherwise calibrated such that the deformable region 124 is in an expanded setting when the spring element 140 is biased toward (e.g., defines a convex surface deformed into) the exhaust channel 116. Thus, when a user depresses the deformable region 124 in the expanded setting toward the substrate, the spring element 140 can buckle from biased toward the fluid conduit 114 to biased away from the exhaust channel 116. Similarly, when the deformable region 124 is in the retracted (e.g., flush with the peripheral region), the spring element 140 can also be biased toward the exhaust channel.

In another implementation, the spring element 140 defines a control surface opposite the exhaust channel 116. In this implementation, the dynamic tactile interface 100 can also include a second displacement device 130B fluidly coupled to the control surface of the spring element 140 and displacing fluid toward the spring element 140 to increase a pressure differential across the spring element. For example, the pressure differential across the spring element 140 can be defined by a pressure gradient between a pressure of fluid adjacent a first face spring element 140 and a second pressure adjacent a second face of the spring element, the second face opposite the spring element 140 from the first face. If the first pressure and the second pressure are equal, the pressure differential across the spring element 140 is negligible, and the spring element 140 maintains the first position. If the first pressure is greater than the second pressure, the pressure differential across the spring element 140 is positive, and the spring element 140 buckles (e.g., bends, deflects, or deforms) away from the exhaust channel 116 when the pressure differential exceeds a threshold (e.g., yield) pressure differential of the spring element 140. Likewise, if the second pressure is greater than the first pressure, the negative pressure differential across the spring element 140 enables (or influences) the spring element 140 to bias back toward the exhaust channel. Thus, the second displacement device 130B can function to regulate buckling of the spring element 140 by manipulating the pressure differential across the spring element. For example, the second displacement device 130B can raise a pressure in the fluid channel, thereby increasing the pressure differential, in order to reduce input force to displace the deformable region 124 toward the substrate. Likewise, in another example, the second displacement device 130B can increase fluid pressure in the closed volume 144 behind the spring element 140 (opposite the exhaust channel 116) such that pressure in the closed volume 144 (further) exceeds fluid pressure is the exhaust channel 116, thereby increasing a magnitude of a force input on the deformable region 124 necessary to trigger the spring element 140 to buckle from the first position to the second position.

In another implementation, the spring element 140 can be stable in both the first position and in the second position. In particular, the spring element 140 can default to the first position as the displacement device 130 transitions the deformable region 124 into the expanded setting, and the spring element 140 can buckle into the second position when a force applied to the deformable region 124 increases the fluid pressure within the fluid circuit past a yield pressure of the spring element. The spring element 140 can, thus, remain in the second position until actively returned to the first position. For example, the spring element 140 can be physically accessible by a user such that a user can manually depress the spring element 140 back into the first position. Alternatively, in the example above, the second displacement device 130B can transiently increase fluid pressure within the closed volume 144 behind the spring element 140 to buckle (or “pop”) the spring element 140 back to the first position and then lower the fluid pressure within the closed volume 144 back to a target back pressure to arm the spring element 140 to generate a click feel at the deformable region 124 in response to a subsequent application of a force on the deformable region 124.

In another example of the foregoing implementation, as shown in FIG. 5A, the spring element 140 includes a bistable spring element 140 stable in the first position and stable in the second position. The second displacement device 130B can be coupled to the closed volume 144 via a control channel and can displace fluid into the control channel to transition the spring element 140 from the second position back into the first position.

Furthermore, the tactile layer 120 can include a second deformable region adjacent the peripheral region 122 and arranged over the second fluid conduit. The displacement device 130 can displace fluid into the fluid channel 112 to transition the deformable region 124 and the second deformable regions substantially simultaneously from the retracted setting to the expanded setting, the second deformable region elevated above the peripheral region 122 in the expanded setting. In this implementation, the dynamic tactile interface 100 can also include a second spring element 140B arranged remotely from the second deformable region, fluidly coupled to the second exhaust channel, and buckling from a first position to a second position in response to application of a force on the tactile surface at the second deformable region in the expanded setting, the second spring element 140B biased toward the second exhaust channel in the first position and biased away from the second exhaust channel in the second position.

Furthermore, one variation of the dynamic tactile interface 100 includes a second spring element 140B coupled to the exhaust channel 116 with (e.g., adjacent) the (first) spring element 140, as shown in FIGS. 4A, 4B, and 4C. In this variation, the second spring element 140B can be configured to buckle from the first position to the second position at a load (i.e., a force or fluid pressure with the fluid system) different from that of the (first) spring element 140. For example, the second spring element 140B can be configured to buckle at a higher fluid pressure within the exhaust channel 116 than the first spring element 140 such that, if a user depresses the deformable region 124 past a first threshold distance, the first spring element 140 buckles to generate a first click feel at the deformable region 124 (as shown in FIG. 4B), but, if the user continues to depress the deformable region 124 past a second threshold distance, the second spring element 140B buckles to generate a second, subsequent click feel at the deformable region 124 (shown in FIG. 4C). In this implementation, the spring elements can also be independently and selectively reset to their first positions to selectively enable the first and second clicks at particular depression distances (which are correlated with different fluid pressures within the fluid system), such as for different functions of the computing device assigned to the deformable region over time. For example, the dynamic tactile interface 100 can include multiple bistable spring elements of different peak loads coupled to the exhaust channel 116, and the dynamic tactile interface 100 can selectively return each of the spring elements to their first positions to enable and disable a click at each corresponding depression distance of the deformable region 124. The dynamic tactile interface 100 can additionally or alternatively selectively lock various spring elements in their first (or second) positions to selectively disable clicks at corresponding depression distances.

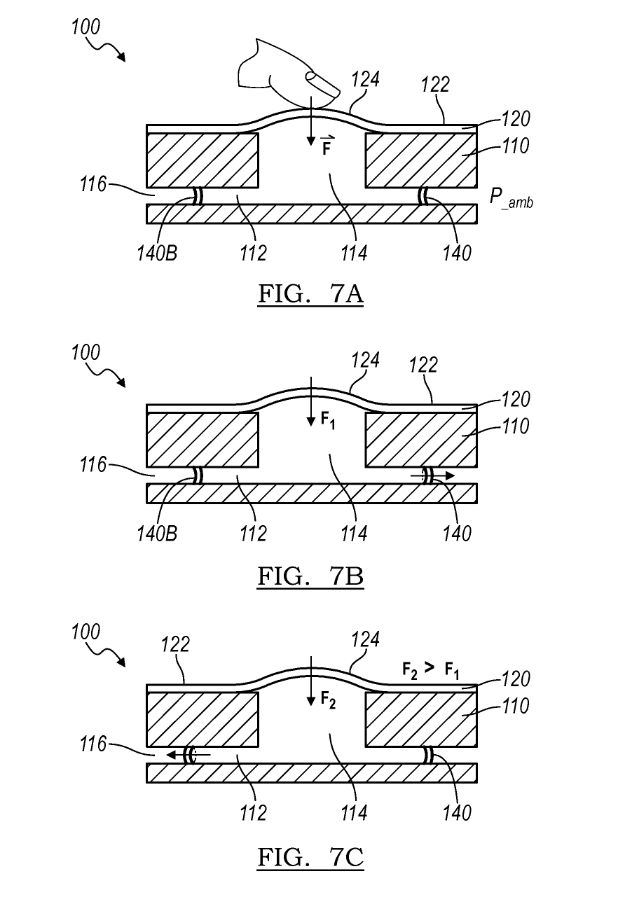

In an example of the foregoing implementation shown in FIGS. 7A, 7B, and 7C, the spring element 140 can buckle from the first position to the second position in response to application of a force of a first magnitude on the tactile surface at the deformable region 124. The dynamic tactile interface 100 can also include the second spring element 140B arranged remotely from the deformable region 124, fluidly coupled to the exhaust channel 116, defining a third internal surface open to the exhaust channel 116 and of a third surface area greater than the second surface area, and buckling from a third position to a fourth position in response to application of a force of a second magnitude on the tactile surface at the deformable region 124, the second spring element 140B biased toward the exhaust channel 116 in the third position and biased away from the exhaust channel 116 in the fourth position, and the second magnitude less than the first magnitude.

In another example, the spring element 140 can be remote from the deformable region 124 by a first fluid distance and remote from the second deformable region by a second fluid distance greater than the first fluid distance. Furthermore, the second spring element 140B can remote from the deformable region 124 by a third fluid distance and remote from the second deformable region by a fourth fluid distance less than the third distance. In this example, a user may depress the deformable region 124 toward the substrate 110, thereby generating a pressure wave within the fluid channel. As the (first) deformable region 124 is nearer the (first) spring element 140 than the second spring element 140B, a pressure wave originating at the (first) deformable region 124 may reach the (first) spring element 140 sooner than the second spring element 140B, thereby causing the (first) spring element 140 to buckle before the second spring element 140B in response to depression of the (first) deformable region 124. Similarly, as the second deformable region is nearer the second spring element 140B than the (first) spring element 140, a pressure wave originating at the second deformable region may reach the second spring element 140B sooner than the (first) spring element 140, thereby causing the second spring element 140B to buckle before the (first) spring element 140B in response to depression of the second deformable region. Thus, the first and second spring elements 140, 140B can be removed by the first and second deformable regions by the first fluid distance and the second fluid distance, respectively, based on locations of inputs on the tactile surface set to trigger buckling of the spring elements.

Alternatively, the first and second spring elements can be configured to buckle at approximately the same fluid pressure, such as to yield a more significant click feel than a spring element. In this implementation, the dynamic tactile interface 100 can further selectively return the spring elements to their first positions (or selectively lock spring elements in their first positions) to adjust a magnitude of a click at a particular distance.

The dynamic tactile interface 100 can additionally or alternatively include a valve arranged between the spring element 140 and the deformable region 124, and the dynamic tactile interface 100 can selectively open and close the valve to enable and disable the spring element, respectively. In this implementation, the dynamic tactile interface 100 can similarly include a valve arranged between the spring element 140 and a second deformable region, between the spring element 140 and multiple deformable regions, between multiple spring elements and the deformable region 124, between two spring elements coupled to one or more deformable regions, or between the spring element 140 and the exhaust manifold, etc. The dynamic tactile interface 100 can further selectively and/or independently change the states of these valves to control haptic (e.g., click) responses from depression of one or more deformable regions. For example, the dynamic tactile interface 100 can include multiple spring elements fluidly coupled to the deformable region 124 with one valve arranged between each spring element 140 and the deformable region 124, and a processor 185 can selectively open and close each of the valves to open and close corresponding spring elements to the deformable region 124, wherein only spring elements coupled to the deformable region 124 via open valves are exposed to increased fluid pressure—and therefore buckle to yield a haptic feel at the deformable region 124—when a downward (e.g., normal) force is applied to the deformable region 124. The dynamic tactile interface 100 can similarly include multiple deformable regions, each coupled to a spring elements via a valve, and the processor 185 can selectively turn haptic effects ON and OFF at particular deformable regions. In particular, in this example, the processor 185 can selectively open and close the valves to expose and isolate, respectively, the corresponding spring elements from increased fluid pressure resulting from depression of corresponding deformable regions.

However, the dynamic tactile interface 100 can include any other number of spring elements of any other shape, form, peak load before buckling, etc. and can actively or passively control the positions of the one or more spring elements in any other suitable way. The one or more spring elements can function in any other way to yield a click feel or otherwise modify a haptic sensation at the deformable region 124 in response to depression of the deformable region 124.

### 6. Sensor

The sensor 181 of the dynamic tactile interface 100 outputs a signal in response to displacement of the deformable region 124 in the expanded setting toward the substrate. Generally, the sensor 181 functions to output a signal corresponding to depression of the deformable region 124.

In one implementation, the sensor 181 includes a touch sensor 181, such as a capacitive or resistive touch panel coupled to or physically coextensive with the substrate. Alternatively, the sensor 181 can include an optical sensor 181 or an ultrasonic sensor 181 that remotely detects a finger, a stylus, or other motion across or above the tactile layer. The sensor 181 can also detect a touch on the tactile surface that does not deform or that does not fully depress (e.g., rests on) one or more deformable regions. However, the sensor 181 can include any other type of sensor 181 configured to output any other suitable type of signal in response to selection and/or depression of one or more deformable regions.

In another implementation, the spring element 140 includes a conductive surface, and the sensor 181 includes a circuit that is open when the spring element 140 is in the first position and that closes when the spring element 140 buckles into the second position (or vice versa). The sensor 181 can similarly include a strain gauge arranged across a portion of the spring element 140 to detect a position of the spring element. Yet alternatively, the sensor 181 can include an optical detector configured to detect a position of the spring element. However, the sensor 181 can implement any other method or technique to detect a position of the spring element. A processor 185 coupled to the sensor 181 can subsequently correlate a detected shift in the spring element 140 from the first position to the second position with an input on the deformable region 124 and respond accordingly. The sensor 181 can also detect the positions of multiple spring elements fluidly coupled to a single exhaust channel 116, and the processor 185 can determine a depression distance of the corresponding deformable region 124 based on known threshold depression distances triggering buckling of each of the spring elements coupled to the exhaust channel. The processor 185 can similarly correlate an output of a strain gauge (or other non-binary sensing element) coupled to the spring element 140 with a depression distance of the corresponding deformable region 124.

However, the sensor 181 can include any other type of sensor configured to output any other suitable type of signal in response to selection and/or depression of one or more deformable regions.

In a similar variation, the dynamic tactile interface 100 further includes a pressure sensor 187 fluidly coupled to the control channel. The dynamic tactile interface 100 can also include a digital memory 183 and a processor 185 electrically coupled to the pressure sensor 187, to the digital memory 183, and to the second displacement device, the processor 185 controlling the second displacement device 130B based on an output of the pressure sensor 187 and one or more user preferences stored in digital memory 183. In particular, processor 185 can control the second displacement device 130B to manipulate a magnitude of force applied on the deformable region 124 necessary to trigger the spring element 140 to buckle.

In another variation, the dynamic tactile interface 100 includes a display 150 coupled to the substrate 110 opposite the tactile layer 120 and rendering a graphical image of an input key substantially aligned with the deformable region 124, wherein the substrate 110 includes a substantially transparent material, and wherein the tactile layer 120 includes a substantially transparent material.

### 7. Housing

A variation of the dynamic tactile interface 100 shown in FIG. 10 can include a housing 190 supporting the substrate, the tactile layer, the displacement device 130, and the spring element, the housing 190 engaging a computing device and retaining the substrate no and the tactile layer 120 over a display 150 of the computing device. The housing 190 can also transiently engage the mobile computing device and transiently retain the substrate no over a display 150 of the mobile computing device. Generally, in this variation, the housing 190 functions to transiently couple the dynamic tactile interface 100 over a display 150 (e.g., a touchscreen) of a discrete (mobile) computing device. For example, the dynamic tactile interface 100 can define an aftermarket device that can be installed onto a mobile computing device (e.g., a smartphone, a tablet) to update functionality of the mobile computing device to include transient depiction of physical guides or buttons over a touchscreen of the mobile computing device. In this example, the substrate no and tactile layer 120 can be installed over the touchscreen of the mobile computing device, a manually-actuated displacement device 130 can be arranged along a side of the mobile computing device, and the housing 190 can constrain the substrate no and the tactile layer 120 over the touchscreen and can support the displacement device. However, the housing 190 can be of any other form and function in any other way to transiently couple the dynamic tactile interface 100 to a discrete computing device.

As a person skilled in the art of will recognize from the previous detailed description and from the figures and claims, modifications and changes can be made to the preferred embodiments of the invention without departing from the scope of this invention defined in the following claims.

I claim:

1. A dynamic tactile interface comprising:
a substrate defining a fluid channel, a fluid conduit fluidly coupled to the fluid channel, and an exhaust channel fluidly coupled to the fluid conduit;
a tactile layer comprising a peripheral region coupled to the substrate, a deformable region adjacent the peripheral region and arranged over the fluid conduit, and a tactile surface opposite the substrate;
a displacement device displacing fluid into the fluid channel to transition the deformable region from a retracted setting to an expanded setting, the deformable region elevated above the peripheral region in the expanded setting;
a spring element arranged remotely from the deformable region, fluidly coupled to the exhaust channel, and buckling from a first position to a second position in response to application of a force on the tactile surface at the deformable region in the expanded setting, the spring element biased toward the exhaust channel in the first position and biased away from the exhaust channel in the second position; and
a sensor outputting a signal corresponding to depression of the deformable region in the expanded setting.

2. The dynamic tactile interface of claim 1, wherein the spring element defines an exterior surface opposite the exhaust channel, the exterior surface open to ambient.

3. The dynamic tactile interface of claim 1, wherein the spring element mechanically couples to the substrate and sealed about an outlet of the exhaust channel.

4. The dynamic tactile interface of claim 1, wherein the spring element defines a control surface opposite the exhaust channel; and further comprising a second displacement device fluidly coupled to the control surface of the spring element by a control channel and displacing fluid toward the spring element to increase a pressure differential across the spring element.

5. The dynamic tactile interface of claim 4, wherein the spring element comprises a bistable spring element stable in the first position and stable in the second position; and wherein the second displacement device displaces fluid into the control channel to transition the spring element from the second position back into the first position.

6. The dynamic tactile interface of claim 4, wherein the second displacement device selectively displaces fluid into the control channel to achieve a target pressure differential across the spring element for the deformable region in the expanded setting and the spring element in the first position based on a user preference for a magnitude of force on the deformable region triggering buckling of the spring element.

7. The dynamic tactile interface of claim 6, further comprising a pressure sensor fluidly coupled to the control channel; further comprising a digital memory; and further comprising a processor electrically coupled to the pressure sensor, to the digital memory, and to the second displacement device, the processor controlling the second displacement device based on an output of the pressure sensor and the user preference, for the magnitude of force on the deformable region triggering buckling of the spring element, stored in the digital memory.

8. The dynamic tactile interface of claim 1, wherein the spring element transitions from the second position to the first position in response to release of the force from the deformable region.

9. The dynamic tactile interface of claim 1, wherein the deformable region defines a first internal surface open to the fluid conduit and of a first surface area; and wherein the spring element defines a second internal surface open to the exhaust channel and of a second surface area less than the first surface area.

10. The dynamic tactile interface of claim 9, wherein the spring element buckles from the first position to the second position in response to application of a force of a first magnitude on the tactile surface at the deformable region; and further comprising a second spring element arranged remotely from the deformable region, fluidly coupled to the exhaust channel, defining a third internal surface open to the exhaust channel and of a third surface area greater than the second surface area, and buckling from a third position to a fourth position in response to application of a force of a second magnitude on the tactile surface at the deformable region, the second spring element biased toward the exhaust channel in the third position and biased away from the exhaust channel in the fourth position, and the second magnitude less than the first magnitude.

11. dynamic tactile interface of claim 1, wherein the deformable region is flush with the peripheral region across the tactile surface in the retracted setting.

12. The dynamic tactile interface of claim 1, further comprising a display coupled to the substrate opposite the tactile layer and rendering a graphical image of an input key substantially aligned with the deformable region; wherein the substrate comprises a substantially transparent material; and wherein the tactile layer comprises a substantially transparent material.

13. A dynamic tactile interface comprising:
a substrate defining a fluid channel, a fluid conduit fluidly coupled to the fluid channel, and an exhaust channel fluidly coupled to the fluid conduit;
a tactile layer comprising a peripheral region coupled to the substrate, a deformable region adjacent the peripheral region and arranged over the fluid conduit, and a tactile surface opposite the substrate;
a displacement device displacing fluid into the fluid channel to transition the deformable region from a retracted setting to an expanded setting, the deformable region elevated above the peripheral region in the expanded setting; and
a spring element fluidly coupled to and sealed about the exhaust channel, the spring element buckling from a first position to a second position in response to application of a force on the tactile surface at the deformable region in the expanded setting, the spring element biased toward the exhaust channel in the first position and biased away from the exhaust channel in the second position.

14. The dynamic tactile interface of claim 13, further comprising a housing configured to transiently engage an exterior of a computing device to transiently retain the substrate over a display of the computing device, the substrate supporting the displacement device.

15. The dynamic tactile interface of claim 14, wherein the spring element defines a control surface opposite the exhaust channel; and further comprising a second displacement device fluidly coupled to the control surface of the spring element and manually actuatable to displace fluid toward the control channel to increase a pressure differential across the spring element.

16. The dynamic tactile interface of claim 13, wherein the substrate defines a bezel area about a periphery of the substrate and supports the spring element adjacent the bezel area.

17. The dynamic tactile interface of claim 13:
wherein the substrate defines a second fluid conduit fluidly coupled to the fluid channel and a second exhaust channel fluidly coupled to the fluid conduit;
wherein the tactile layer comprises a second deformable region adjacent the peripheral region and arranged over the second fluid conduit;
wherein the displacement device displaces fluid into the fluid channel to transition the deformable region and the second deformable region substantially simultaneously from the retracted setting to the expanded setting, the second deformable region elevated above the peripheral region in the expanded setting; and
further comprising a second spring element arranged remotely from the second deformable region, fluidly coupled to the second exhaust channel, and buckling from a first position to a second position in response to application of a force on the tactile surface at the second deformable region in the expanded setting, the second spring element biased toward the second exhaust channel in the first position and biased away from the exhaust channel in the second position.

18. The dynamic tactile interface of claim 17:
wherein the spring element is remote from the deformable region by a first fluid distance;
wherein the spring element is remote from the second deformable region by a second fluid distance greater than the first fluid distance;
wherein the second spring element is remote from the deformable region by a third fluid distance; and
wherein the second spring element is remote from the second deformable region by a fourth fluid distance less than the third distance.

19. The dynamic tactile interface of claim 13, wherein the spring element buckles in response to elevation of pressure within the exhaust channel exceeding a threshold buckling pressure responsive to application of a force on the deformable region.

20. dynamic tactile interface of claim 19, wherein the spring element comprises a metallic snap dome stable in the first position and volatile in the second position.
